(19) United States
(12) Patent Application Publication
(10) Pub. No.: US 2008/0187743 A1
(43) Pub. Date: Aug. 7, 2008

(54) Resin-Coated Metal Sheet

(75) Inventors: Hiroo Shige, Hyogo (JP); Masatoshi Iwai, Hyogo (JP); Kazuhisa Fujisawa, Hyogo (JP); Hironobu Nakanishi, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA KOBE SEIKO SHO (Kobe Steel, Ltd.), Kobe-shi (JP)

(21) Appl. No.: 11/568,931

(22) PCT Filed: Jul. 7, 2005
(86) PCT No.: PCT/JP05/12587

§ 371 Date: Nov. 10, 2006

(30) Foreign Application Priority Data
Jul. 9, 2004 (JP) 2004-203890

(51) Int. Cl. B32B 5/16

(52) U.S. Cl. 428/327

(57) ABSTRACT

A resin-coated metal sheet having a metal sheet and a resin layer containing electroconductive particles provided on the surface of the metal sheet is characterized in that t (μm), r (μm), d₈₄ (μm) and d₁₆ (μm) satisfy the following expressions 2.0≦t≦16, 0.25t≦r≦2t, and SD=(d₈₄-d₁₆)/2≦0.8r, wherein t represents the film thickness (μm) of the resin layer, r represents a volume average particle diameter (μm) of the electroconductive v articles, and d₈₄ and d₁₆ represent the particle diameters (μm) at cumulative percentages of 84% and 16%, respectively in the cumulative particle diameter distribution of the electroconductive particles.

### TECHNICAL FIELD

The present invention relates to a resin-coated metal sheets more specifically to a rust-proofing coated steel sheet for automobiles.

### BACKGROUND ART

Responding to the cost down through the elimination of waxing and sealing processes by automobile manufacturers, European automakers are using an organic film coated steel sheet containing Zn particles such as BONAZINC as a steel sheet which can be guaranteed for 12 years of a perforative corrosion resistant steel sheet. Recently, an organic film coated steel sheet containing iron phosphide as electroconductive particles has been considered to meet an increasing need of high corrosion resistance (for example, Japanese Patent Laid-Open Nos. H11-5269 and H11-216420). Compared with the Zn particle type, the organic film coated steel sheet containing iron phosphide has merits of low price, good scratch resistance, good corrosion resistance of a processing part, and high number of continuous spot welding (weldability).

However, electroconductive particles of iron phosphide are hard, stable matter and thus, their adhesion with the organic film is low. In consequence, the organic film is easily exfoliated or peeled off during the processing and damages a mold. Although the film exfoliation problem during the processing may be overcome by reducing the content of iron phosphide in the film, it gives rise to another problem, i.e., weldability is not secured. At present, the organic film coated steel sheet containing electroconductive particles of iron phosphide has not yet reached the level for practical use.

### DISCLOSURE OF THE INVENTION

Problem to be Solved by the Invention

The inventors have made progress in their research on the above object and introduced as part of the research a technique like the one in Japanese Patent Application No. 2003-131825. This technique suggests that a weldable resin coated metal sheet employing iron phosphide as electroconductive particles exhibits enhanced corrosion resistance, weldability, and formability at the same time. Unfortunately however, there was a problem that the exfoliability of iron phosphide during the processing was not demonstrated even in the above coated metal sheet depending on cases.

Therefore, the present invention has been made in view of the above problem, and it is an object of the present invention to provide a resin-coated metal sheet excellent not only in weldability and corrosion resistance but also in formability and especially peeling resistance, and a manufacturing method thereof.

Means for Solving the Problem

In accordance with an aspect of the present invention, the above and other objects can be accomplished by the provision of a resin-coated metal sheet having a resin layer containing electroconductive particles provided on the surface of the metal sheet is characterized in that t (μm), r (μm), d₈₄ (μm), and doc (μm) satisfy the following expressions:

### [Expressions 1]

2.0≦t≦16 (1)

0.25t≦r≦2t (2)

SD=(d₈₄-d₁₆)/2≦0.8r (3)

wherein t represents the film thickness (μm) of the resin layer, r represents a volume average particle diameter (μm) of the electroconductive particles, and d₈₄ and d₁₆ represent the particle diameters (μm) at cumulative percentages of 84% and 16%, respectively, in the cumulative particle diameter distribution of the electroconductive particles.

First, it is assumed that the film thickness t of the resin layer containing electroconductive particles is not less than 2.0 μm nor greater than 16 μm. The film thickness of the resin layer is known to affect the manufacturing cost, weldability, corrosion resistance and the like. Thus, by setting the film thickness within a range of 2.0 μm to 16 μm, a resin layer excellent in manufacturing cost, weldability and corrosion resistance can be obtained. In addition, the film thickness t and the volume average particle diameter r should satisfy the expression (2). In order to obtain a desired weldability and peeling resistance, it is necessary to use electroconductive particles having an adequate volume average particle diameter r according to the film thickness t of the resin layer. Furthermore, the particle diameter distribution of the electroconductive particles and the volume average diameter r should satisfy the expression (3). In the expressions, SD represents a wideness of the particle diameter distribution. As SD increases, the particle diameter distribution becomes broad; as SD decreases, the particle diameter distribution becomes narrow. And, by specifying the condition as in the expression (3), electroconductive particles with a uniform particle diameter can be dispersed on the resin layer of a uniform film thickness t, which in turn suppresses a dropout of the electroconductive particles and improves peeling resistance.

The resin-coated metal sheet of the present invention is excellent in corrosion resistance and formability (especially, peeling resistance of the resin layer). Moreover, when the resin-coated metal sheet of the present invention is utilized as an automobile rust-proofing coated steel sheet, one coating process of an automobile can be omitted, which leads to an increase of production efficiency of automobile manufacture and cost reduction in manufacturing.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of bending test equipment.

### BEST MODE FOR CARRYING OUT THE INVENTION

The resin-coated metal sheet of the present invention has a resin layer containing electroconductive particles formed on the surface thereof and is characterized in that t (μm), r (μm), d₈₄ (μm), and d₁₆ (μm) satisfy the following expressions:

### [Expressions 2]

2.0≦t≦16 (1)

0.25t≦r≦2t (2)

SD=(d₈₄-d₁₆)/2≦0.8r (3)

wherein t represents the film thickness (μm) of he resin layer, r represents a volume average particle diameter (μm) of the electroconductive particles, and d₈₄ and d₁₆ represent the particle diameters (μm) at cumulative percentages of 84% and 16%, respectively, in the cumulative particle diameter distribution of the electroconductive particles.

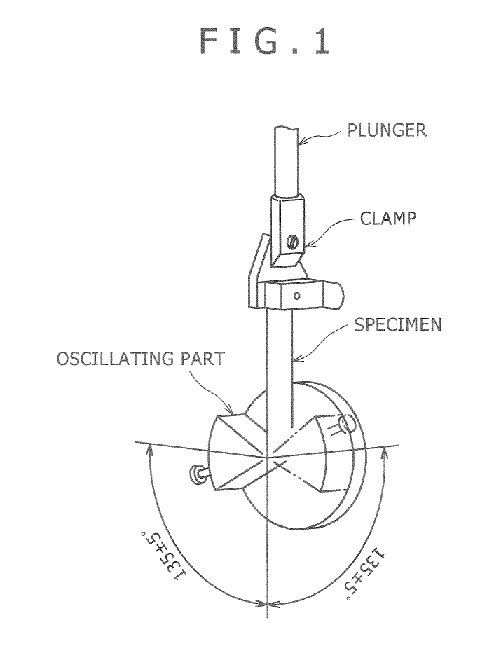

First of all, the resin layer containing electroconductive particles will be explained. Resin components of the resin layer containing electroconductive particles include, for example, an epoxy resin, an acrylic resin, a urethane resin, a polyester resin and the like. Preferably, the epoxy resin, more preferably, a flexible epoxy resin is used. The flexible epoxy resin is used because it can improve powdering resistance at the time of processing. Here, the flexible epoxy is an epoxy which can be bent 300 times or more before it is cracked in an MIT flexural test. The MIT flexural test is carried out by sandwiching one end of a specimen having a width of 15 mm and a length of 130 mm with the clamp of a testing device shown in FIG. 1 and bend the end, moving the other end of the specimen at a tension of 1 kgf, a rotational angle of 135°, and a rotational vibration of 175 times/min to measure the number of times of bending before it is cracked.

The flexible epoxy resin is preferably one of urethane modified epoxy resin and dimer acid modified epoxy resin for example. The urethane modified epoxy resin is obtained by introducing a urethane bond (resin) into the molecular structure of an epoxy resin so that flexibility is provided by the urethane resin structure. In addition, the dimer acid modified epoxy resin is, for example, the Epicoat 872 manufactured by Japan Epoxy Resins Co., Ltd. The dimer acid modified epoxy resin Epicoat 872 is preferably used as a mixture of the Epicoat 1007 bisphenol A type epoxy resin and the Epicoat 872 (872/1007) in a ratio of ½ (mass ratio). Moreover, the epoxy resin used for the present invention can be either in a liquid phase or a solid phase. In case a solid epoxy resin is used, it can be diluted in a solvent, for example.

Also, the resin layer of the present invention has the above resin components preferably cured with a curing agent. Examples of such curing agent include blocked isocyanate, melamine resin, and amine hardener. Out of these, blocked isocyanate and melamine resin react with the hydroxyl group of the epoxy resin, while the amine hardener reacts with the epoxy group of the epoxy resin to harden the epoxy resin. The ratio of the equivalent of the reactive group in the epoxy resin to the equivalent of the reactive group in the curing agent is preferably not less than 0.8 nor greater than 1.2.

The blocked isocyanate is obtained, for example, by blocking an isocyanate group with caprolactam or oxime. For instance, a blocking agent is dissociated at around 150° in the case of caprolactam, and a blocking agent is dissociated at 120-130° C. in the case of oxime.

Examples of the melamine resin include n-butyletherified melamine resin, isobutyletherified melamine resin and methyletherified melamine resin.

Examples of the amine harder include an aliphatic polyamine, alicyclic polyamine, aromatic polyamine or polyamide amine. In detail, the aliphatic polyamine is selected from a group consisting of diethylene triamine, dipropylene triamine, triethylene tetramine, tetraethylene pentamine, dimethylamino propylamine, diethylamino propylamine, dibutylamino propylamine, hexamethylene diamine, N-aminoethyl piperazine, bis-aminopropyl piperazine, trimethylhexamethylene diamine, etc.

The alicyclic polyamine is selected from a group consisting of: 3,3′-dimethyl-4,4′-diaminodicyclohexylmethane, 3-amino-1-cyclohexylaminopropane, 4,4′-diaminodicyclohexylmethane, isophoronediamine, 1,3-bis(aminomethyl)cyclohexane, N-dimethylcyclohexylamine, heterocyclic diamines, etc.

The aromatic polyamine is selected from a group consisting of: xylylene diamine, 4,4′-diaminodiphenylmethane, 4,4′-diaminodiphenyl ether, diaminodiphenylsulfone, m-phenylenediamine, etc. The polyamide amine is, for example, polyamide resin or polyamino amide.

Next, the electroconductive particles contained in the resin layer of the present invention will be explained. There is no specific limit to the electroconductive particles as long as particles have electroconductivity, but metal powder, such as nickel, zinc, aluminum, silver, and copper, carbon black, iron phosphide, zinc oxide, titanium oxide, etc. can be used. The electroconductive particle may be used singly, or in a mixture of more than two kinds. Particularly, iron phosphide is preferred because it can enhance weldability and formability even more.

Desirably, the content of the electroconductive particles in the resin layer is not less than 40 mass % nor greater than 45 mass %. Although workability is good in the content of the conductive particles being under 40 mass %, weldability may be deteriorated. The content of the electroconductive particles in the resin layer is not greater than 60 mass %, more preferably not greater than 55 mass %. Even though weldability is good in the content of the conductive particles being greater than 60 mass %, workability may be deteriorated.

In the present invention, the film thickness t (μm) of the resin layer containing electroconductive particles satisfies the following expression:

### [Expression 3]

2.0≦t≦16 (1)

That is, the film thickness t (μm) of the resin layer containing electroconductive particles of the present invention is set to 2.0 μm or greater, more preferably not less than 4 μm nor greater than 16 μm, more preferably not greater than 8 μm. In the case that the film thickness of the resin layer is under 2.0 μm, there is a possibility that corrosion resistance may be deteriorated. Especially, the particle diameter of an electroconductive particle may become large relatively that it could be perforated from the resin layer. In such case, corrosion resistance by the resin layer may be deteriorated even further. Meanwhile, when the film thickness t of the resin layer exceeds 16 μm, there is a possibility that weldability may be deteriorated.

Moreover, in the present invention, the film thickness t (μm) and the volume average particle diameter r satisfy the following expression:

### [Expression 4]

0.25t≦r≦2t (2)

That is, in order to obtain predetermined weldability and peeling resistance, it is necessary to use electroconductive particles having an adequate volume average particle diameter r according to the film thickness t of the resin layer. And, making the volume average particle diameter r extremely small with respect to the film thickness t (r<0.25t) causes deteriorations in weldability due to the increase in the welding conductive point. On the contrary, if the volume average particle diameter r is too large with respect to the film thickness t (r>2t), conducive particles are dropped. Preferably, the volume average particle diameter r is no less than 0.3t and no more than 1.8t.

In addition, in the present inventions the particle diameter distribution SD and the volume average particle diameter r of the electroconductive particles satisfy the following expression:

### [Expression 5]

SD=(d₈₄-d₁₆)/2≦0.8r (3)

In the expression, SD=(d₈₄-d₁₆)/2 indicates a wideness of the particle diameter distribution. As SD increases, the particle diameter distribution becomes broad; as SD decreases, the particle diameter distribution becomes narrow. And, by specifying the condition as in the expressions (1)-(3), electroconductive particles with a controlled particle diameter distribution is evenly dispersed in the resin layer of a uniform film thickness t, which in turn suppresses a dropout of the electroconductive particles and improves peeling resistance. On the other hand, if the expression (3) is not satisfied, the percentage of large electroconductive particles having an adverse effect on peeling increases, a dropout of electroconductive particles occurs, and peeling at the time of processing is deteriorated. Furthermore, the SD is preferably 0.6r or less.

For the electroconductive particles satisfying the expressions (2) and (3) of the present invention, commercial electroconductive particles may be purchased, which are then ground with a ball mill and are sized using a screen or a mesh. That is, the diameter of the particles is set to fall within a predetermined range by using a mesh of plural rough calibrations. For example, electroconductive particles available from Glenn Spring Holdings can be acquired.

Besides the above-described resin components and electroconductive particles, the resin layer of the present invention can further contain a rust-proofing agent or an antisetting agent. By containing the rust-proofing agents corrosion resistance can be further improved. Examples of the rust-proofing agent include, for examples aluminum tripolyphosphate, calcium ion exchange silica, amorphous magnesium silicate compound, etc.

The content of the rust-proofing agent in the resin layer is 5 mass % or mores more preferably 8 mass % or more. By setting the content to 5 mass % or more, corrosion resistance can be improved more. In additions the content of the rustproofing agent is 25 mass % or below, or preferably 20 mass % or below. This is because if the content of the rustproofing agent exceeds 25 mass %, formability is deteriorated.

In the present invention, a zinc plated metal sheet is desirably used as a base sheet to be coated with a resin layer. There is no specific limit to the zinc plated metal sheet as long as a metal sheet is plated with zinc. For example, an electro-galvanized steel sheet (EG), hot-dipped galvanized steel sheet in coil (GI), galvannealed steel sheet (GA) and the like may be used. When an electro-galvanized steel sheet (EG) or the hot-dipped galvanized steel in coil is used, it is important to form an undercoat (treatment with a chromate or non-chromate (phosphoric acid-based)) before the formation of the resin layer. When a galvannealed steel sheet is used, an undercoat treatment may be performed according to need.

The following will now explain a manufacturing method of the resin-coated metal sheet of the present invention. For the resin-coated metal sheet of the invention, a resin composition for the resin layer is first prepared by adding electroconductive particles to, for example, solution, aqueous solution, or emulsion, plus a rust-proofing agent, an antisetting agent, etc., if necessary. Next, the coating resin composition is coated onto the surface of a metal sheet to a predetermined film thickness, and is dried to obtain a resin-coated metal sheet. The drying condition may be appropriately performed according to the coating resin composition being used. For instance, if the coating resin composition is an aqueous resin composition, the drying process is performed at a temperature of 70° C. or higher, preferably in a range of 90° C. to 150° C., and more preferably in a range of 90° C. to 120° C. for longer than 3 seconds, more preferably for 30 seconds to 2 minutes, and more preferably not longer than 1 minute. Meanwhile, if the resin composition is a resin composition in a solvent system, the drying temperature and the drying time are set up according to the kind of a curing agent used. When a curing agent is included in the resin components of the resin layer, a heat treatment is preferably carried out concurrently with the drying process or after the drying process to accelerate the curing reaction of the resin components.

### EXAMPLES

While the invention is described in more details with reference to certain preferred examples thereof, it is to be understood that the invention is not limited to the following examples It is also to be understood that various changes and modifications in form and details made are all included in the scope of the invention.

### Evaluation Methods

(1) Particle Size Distribution and Volume Average Particle Diameter of Electroconductive Particles

Using micro truck FRA9220 manufactured by Leeds & Northrup Co., a laser diffraction (scattering) was performed for measurement.

Measurement range: 0.12-714 μm, Solvent:water

These are the typical measurement method and condition for particle size distribution.

(2) Evaluation Method of Formability (Peeling Resistance)

(2-1) Deep drawing was carried out under the following conditions.

<Deep Drawing Conditions>
Spot diameter of resin coated metal sheet (blank diameter for deep drawing): 90 mm
Punch diameter (outer diameter): 50 mm
Die diameter (inner diameter): 52 mm
BHF (Bland Holding Force): 980N
Deep drawing rate: 160 mm/min

(2-2) A tape was forcedly removed from the surface after the deep drawing. That is, an adhesive tape (Cellophane tape) was affixed to the surface of the cylindrical portion of a deep drawn product obtained by the deep drawing (bottomed cylinder) and forcedly peeled off.

(2-3) A reduction in the weight (W_{d}) of the deep drawn product by affixing and removing the adhesive tape was measured. That is, the weight W₁ of the deep drawn product before the adhesive tape was affixed to the product and the weight W₂ of the deep drawn product after the adhesive tape was affixed and removed was measured to obtain a weight difference between them (W₁-W₂=W₁₋₂) which was divided by the surface area (S) of the adhesive tape affixed portion of the deep drawn product so as to obtain a weight reduction (W_{d}=W₁₋₂/S).

(2-4) Criteria of formability are given below.

<Criteria of Formability>

Weight reduction (W_{d}): X (poor formability), when it is 3 g/m² or more
Weight reduction (W_{d}): X (superior to X and in an allowable range) when it is 2 g/m² or more and less than 3 g/m²
Weight reduction (W_{d}): ◯ (excellent formability), when it is less than 2 g/m².

[Fabricating a Resin-Coated Metal Sheet]

For a metal sheet, a galvannealed steel sheet (GA) with 45 g/m² of adhesion that easily produces electroconductive powder was used, and an undercoat (treatment with a non-chromate) was formed using PPG's Nupal. The amount of adhesion to the undercoat was coated with barcode so that the strength of P under fluorescent X-rays is 1.

For the preparation of a coating agent forming the resin layer, 38, 28 mass % of an epoxy resin (manufactured by Mitsui Chemicals, inc. Product name: Epokey 834), 50, 60 mass % of iron phosphide as electroconductive particles, 2 mass % of fumed silica as an antisetting agent, and 10 mass % of amorphous magnesium silicate (a total of 100 mass %) as a rust-proofing agent were mixed and were diluted in a mixed solvent of xylene/propylene glycol monomethyl ether acetate/n-butanol=4/3/1, whereby the evaporated residue amounted to 50%.

Next, a bar coater was selected so that the thickness of the resin layer formed of the coating composition thusly obtained can be set to 1.8-8 μm, and the resin layer was coated onto the galvannealed steel sheet (GA) which underwent the undercoat treatment. The solvent therein was removed with aid of a continuous heating furnace at PMT 230° C., and the resin layer was hardened to obtain the resin-coated metal sheet.

The evaluation results of the particle size distribution or electroconductive particles used and of the resin-coated metal sheet obtained are summarized in Table 1.

TABLE 1

| | | Content of | | | | | | |
|---|---|---|---|---|---|---|---|---|
| Metal | Film | Iron | Volume | | | | | |
| Sheet | Thickness | Phosphide | Average | | | | | |
| No. | (μm) | (%) | Diameter (r) | 0.25t | 2t | SD | 0.8r | Formability |
| 1 | 3 | 50 | 3.06 | 0.75 | 6 | 1.37 | 2.45 | ◯ |
| 2 | 5 | 50 | 3.06 | 1.25 | 10 | 1.37 | 2.45 | ◯ |
| 3 | 8 | 50 | 3.06 | 2 | 16 | 1.37 | 2.45 | ◯ |
| 4 | 3 | 50 | 3.69 | 0.75 | 6 | 2.89 | 2.95 | Δ |
| 5 | 5 | 50 | 3.69 | 1.25 | 10 | 2.89 | 2.95 | ◯ |
| 6 | 8 | 50 | 3.69 | 2 | 16 | 2.89 | 2.95 | ◯ |
| 7 | 3 | 50 | 5.12 | 0.75 | 6 | 3.25 | 4.10 | Δ |
| 8 | 5 | 50 | 5.12 | 1.25 | 10 | 3.25 | 4.10 | ◯ |
| 9 | 8 | 50 | 5.12 | 2 | 16 | 3.25 | 4.10 | ◯ |
| 10 | 3 | 50 | 5.23 | 0.75 | 6 | 4.23 | 4.18 | X |
| 11 | 5 | 50 | 5.23 | 1.25 | 10 | 4.23 | 4.18 | X |
| 12 | 8 | 50 | 5.23 | 2 | 16 | 4.23 | 4.18 | X |
| 13 | 3 | 60 | 3.06 | 0.75 | 6 | 1.37 | 2.45 | ◯ |
| 14 | 5 | 60 | 3.06 | 1.25 | 10 | 1.37 | 2.45 | ◯ |
| 15 | 8 | 60 | 3.06 | 2 | 16 | 1.37 | 2.45 | ◯ |
| 16 | 3 | 60 | 3.69 | 0.75 | 6 | 2.89 | 2.95 | Δ |
| 17 | 5 | 60 | 3.69 | 1.25 | 10 | 2.89 | 2.95 | Δ |
| 18 | 8 | 60 | 3.69 | 2 | 16 | 2.89 | 2.95 | ◯ |
| 19 | 3 | 60 | 5.12 | 0.75 | 6 | 3.25 | 4.10 | Δ |
| 20 | 5 | 60 | 5.12 | 1.25 | 10 | 3.25 | 4.10 | Δ |
| 21 | 8 | 60 | 5.12 | 2 | 16 | 3.25 | 4.10 | Δ |
| 22 | 3 | 60 | 5.23 | 0.75 | 6 | 4.23 | 4.18 | X |
| 23 | 5 | 60 | 5.23 | 1.25 | 10 | 4.23 | 4.18 | X |
| 24 | 8 | 60 | 5.23 | 2 | 16 | 4.23 | 4.18 | X |
| 25 | 1.8 | 50 | 3.06 | 0.45 | 3.6 | 1.37 | 2.45 | X |
| 26 | 2 | 50 | 5.12 | 0.5 | 4 | 3.25 | 4.10 | X |

As evident from Table 1, the resin-coated metal sheet satisfying the expressions (1)-(3) is excellent in peeling resistance. On the other hand, metal sheets of 10-12 and 22-24 are the cases where the expression (3) is not satisfied and thus, peeling resistance thereof was deteriorated. A metal sheet 25 is the case where the expression (1) is not satisfied and peeling resistance and corrosion resistance were deteriorated (red rust was generated in 10 cycles of VDA test mating part). Furthermore, a metal sheet 26 is the case where the expression (2) is not satisfied and peeling resistance was deteriorated because the volume average particle diameter increased too much with respect to the film thickness t.

Resin-coated metal sheets satisfying the expressions (1)-(3) had higher than 1000 points of continuous spot welding, did not produce red rust at 15 cycles of VDA test mating part, and were excellent in weldability as well as corrosion resistance.

### INDUSTRIAL APPLICABILITY

The resin-coated metal sheet of the present invention is suitable for use in a weldable coated metal sheet that is frequently used in steel sheets for automobiles, home appliances, etc.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A resin-coated metal sheet having a resin layer containing electroconductive particles provided on the surface of the metal sheet,
wherein t (μm), r (μm), d₈₄ (μm), and d₁₆ (μm) satisfy the following expressions:
2.0≦t≦16
0.25t≦r≦2t
SD=(d₈₄-d₁₆)/2≦0.8r, [Expressions 1]
wherein t represents the film thickness (μm) of the resin layer, r represents a volume average particle diameter (μm) of the electroconductive particles, and d₈₄ and d₁₆ represent the particle diameters (μm) at cumulative percentages of 84% and 16%, respectively, in the cumulative particle diameter distribution of the electroconductive particles.

2. The resin-coated metal sheet according to claim 1 wherein the electroconductive particle is iron phosphide.

3. The resin-coated metal sheet according to claim 1, wherein content of the electroconductive particles in the resin layer ranges 40 to 60 mass %.

4. The resin-coated metal sheet according to claim 1, wherein the resin layer is an epoxy resin.

5. The resin-coated metal sheet according to claim 1, wherein the resin layer is a flexible epoxy resin which can be bent 300 times or more before it is cracked in an MIT flexural test.

6. The resin-coated metal sheet according to claim 1, wherein the resin layer is cured (hardened) by a curing agent.

7. The resin-coated metal sheet according to claim 1, wherein the film thickness t (μm) of the resin layer and the volume average particle diameter r (μm) of the electroconductive particle satisfy the following expression:
0.3t≦r≦1.8t [Expression 2]
